(19) United States
(12) Patent Application Publication
(10) Pub. No.: US 2014/0089133 A1
(43) Pub. Date: Mar. 27, 2014

(54) TECHNIQUES FOR DETERMINING SUBSTITUTES FOR PURCHASED ITEMS IN A PURCHASE HISTORY OF A USER

(71) Applicants: Stuart Argue, Palo Alto, CA (US); Anthony Emile Marcar, San Francisco, CA (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/628,906

(22) Filed: Sep. 27, 2012

(51) Int. Cl. G06Q 30/00

(52) U.S. Cl. 705/26.7

(57) ABSTRACT

Systems and methods are disclosed for determining a set of substitutes to recommend to a user. In some embodiments, a method includes receiving a product indicator from a remote computing device, with the product indicator being indicative of a brand of a product sold by a retailer. The method also includes determining one or more potential substitutes for the product based on the product indicator, wherein a plurality of attributes are associated with each potential substitute, including a substitute cost corresponding to the potential substitute and a substitution weight corresponding to the potential substitute. The method also includes for each of the one or more potential substitutes, determining a score of the potential substitute based on the plurality of attributes associated with the potential substitute. The method further includes determining a set of recommended substitutes based on the scores and providing the set of recommended substitutes to the remote computing device.

### BACKGROUND INFORMATION

1. Field of the Disclosure

The present invention relates generally to systems and methods for generating an electronic shopping list. In particular, examples of the present invention are related to techniques for determining substitutes to recommend for purchased items in a purchase history of a user based on attributes of the substitutes.

2. Background

Many consumers collect coupons or search through sale announcements when preparing to shop for products such as groceries, office supplies, and household wares. Typically, coupons and/or sale announcements are distributed to shoppers electronically or through the mail. Consumers may spend significant time teeming through the coupons and sale announcements in an effort to find deals and ultimately reduce the amount of money spent on products. One drawback for the consumers, however, is that the amount of money that they spend on products may actually increase as they purchase products that they otherwise would not have purchased due to the perceived savings associated with the coupons and/or sale announcements.

Another drawback with coupons and sale announcements is that consumers may be swayed from purchasing a preferred product to purchasing an alternative product due to the enticement of the coupon or sale. For example, a consumer who typically purchases PEPSI® or COKE® may be swayed into purchasing a private label cola due to the reduced price of the private label cola. It may be that the private label cola is low quality and not an acceptable substitute for PEPSI® or COKE®. Thus, any savings realized by the consumer may be diminished by the fact that the consumer finds the substitute to be unacceptable.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIGS. 1A-1C are schematics illustrating a computing device displaying a graphical user interface in communication with a substitution server in accordance with some embodiments of the present disclosure;

FIG. 2 is a block diagram illustrating components of the computing device of FIGS. 1A-1C;

FIG. 3 is a flow chart illustrating an example method for generating a modified electronic shopping list in accordance with some embodiments of the present disclosure;

FIG. 4 is a block diagram illustrating components of the substitution server of FIGS. 1A-1C;

FIG. 5 is a flow chart illustrating an example method for determining a purchase history of a user; and

FIG. 6 is a flow chart illustrating an example method for determining a set of substitutes for a purchased item in accordance with some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment,” “an embodiment,” “one example,” or “an example” means that a particular feature, structure, or characteristic described in connection with the embodiment or example is included in at least one embodiment of the present invention. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, and the like), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., a private cloud, a community cloud, a public cloud, or a hybrid cloud).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, as well as combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture, including instruction means which implement the function/act specified in the flowchart and/or block diagram block or blocks.

In addition to or in lieu of collecting coupons and searching sale announcements, many consumers prepare shopping lists when preparing to shop for products. As used herein, the term “product” can refer to groceries, foods, office supplies, clothing wares, or any other fungible goods sold by a retailer. Furthermore, many consumers typically purchase products that they have previously purchased. Thus, the shopping lists of these consumers may contain items that are repeated in subsequent shopping lists.

Some consumers utilize the capabilities of their computing devices to prepare their shopping lists. For example, a user of a computing device may prepare an electronic shopping list containing one or more items that each indicate a different product that the user intends to purchase. The shopping list can be stored by the computing device and later accessed while the user is shopping. As used herein, the term “computing device” can refer to mobile computing devices such as mobile telephones, laptop computers, and tablet computers, or stationary computing devices. Users of mobile computing devices can store the shopping list on the mobile computing device and access the shopping list while shopping. Users of a stationary computing device can print a paper copy of the shopping list or can send the shopping list to a mobile computing device, either of which can be accessed while shopping.

In accordance with various embodiments of the present disclosure, techniques are described for obtaining a purchase history of a user indicating one or more purchased items. As used herein, the term “item” can refer to any type of indicator of a product sold by a retailer and the term “purchased item” can refer to a purchased product previously bought by a user from the retailer. Further, the term “purchase history” can refer to a list of purchased items.

Additionally, techniques are described for determining recommended substitutes for the purchased items appearing in the electronic shopping list. As used herein, a “substitute” can indicate one or more substitute products that can be substituted for a particular product. Additionally, techniques are disclosed for allowing a user to generate an electronic shopping list on a computing device using the purchase history and the recommended substitutes.

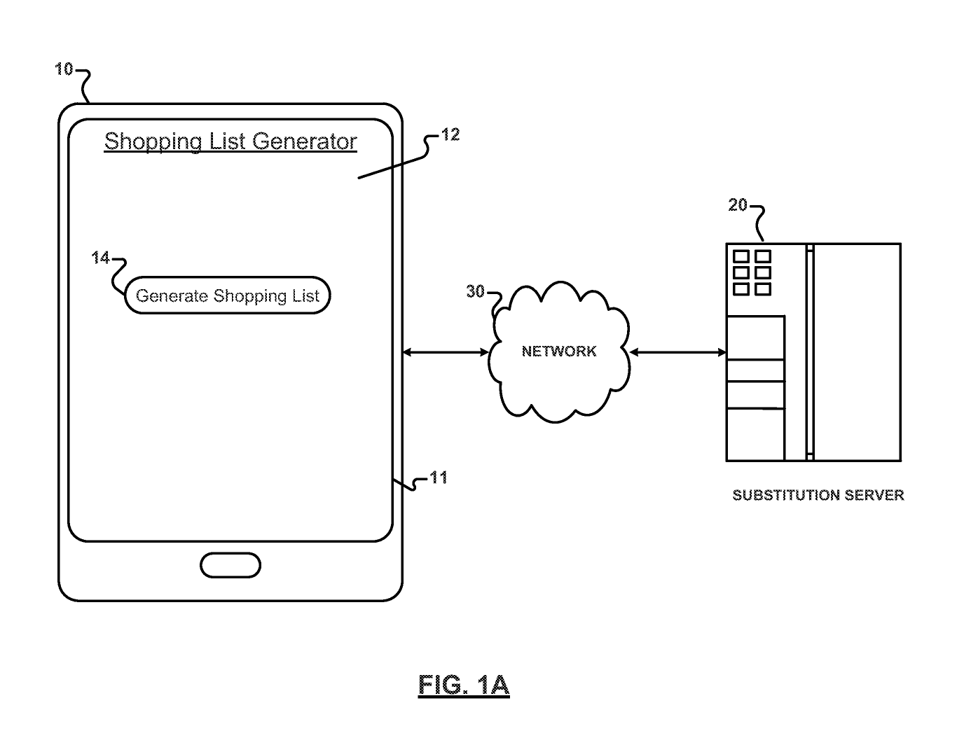

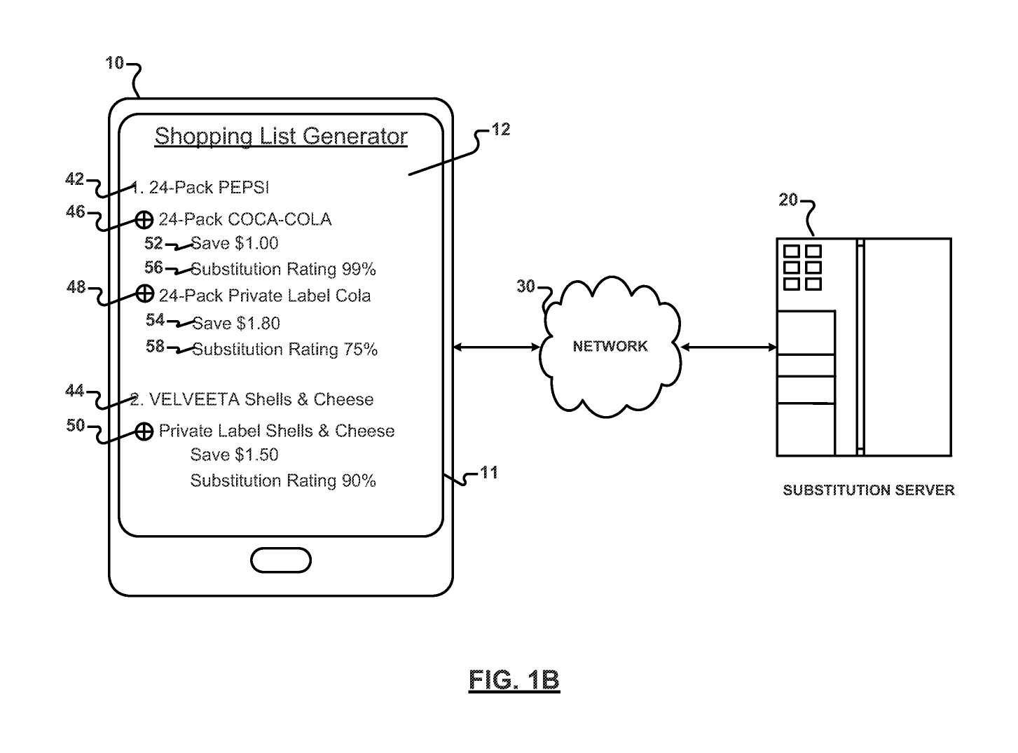

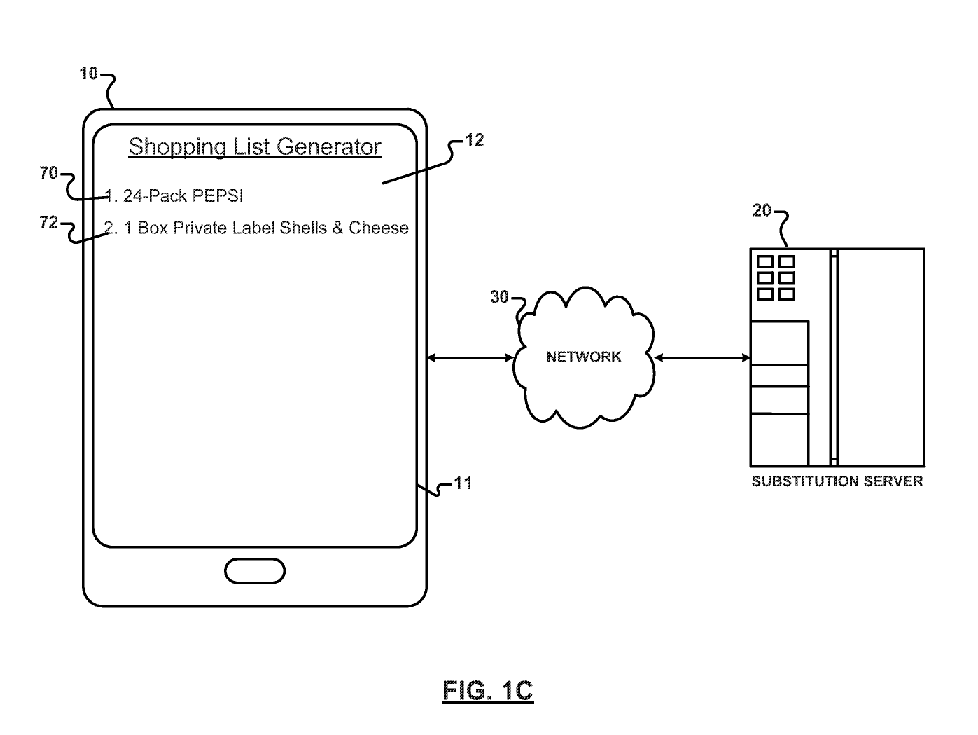

Referring now to FIG. 1A, a computing device 10 in communication with a substitution server 20 via a network 30 is illustrated. While one substitution server 20 is illustrated, the term “substitution server” refers to one or more servers that operate in an individual or distributed manner. Further, as used herein, the term “network” can refer to any communication network including, but not limited to, a wireless network, a cellular network, an intranet, the Internet, or combinations thereof. In the illustrated example, the computing device 10 is displaying a graphical user interface (GUI) 12 on a touch screen 11 of the computing device 10. While a touch screen 11 is illustrated, it should be appreciated that other user interfaces can be used to allow a user to interact with the computing device 10.

In one embodiment, the GUI 12 allows a user to generate an electronic shopping list based on the purchase history of the user and one or more recommended substitutes for purchased items appearing in the purchase history. In the illustrated example, the GUI 12 is displaying a button 14 that allows the user to request to generate an electronic shopping list. In this example, the user can provide user input, i.e., press the button 14, to generate the request. In some embodiments, the button 14 is a “one-tap” button. A “one-tap” button is a button that when selected by a user automatically sends the request to the substitution server 20 without any additional confirmation from the user.

In response to the user input, the request is transmitted to the substitution server 20. The request can include an indicator of the user, i.e., a username. The substitution server 20 receives the request and determines a purchase history, i.e., one or more purchased items, of the user. From the purchase history, the substitution server 20 determines sets of recommended substitutes for one or more of the purchased items. The substitution server 20 can then transmit the purchase history and the sets of recommended substitutes to the computing device 10 via the network 30.

In some embodiments, the substitution server 20 can provide recommended substitutes for a portion of the purchased items. For example, the substitution server 20 may be unable to determine an acceptable substitute for an item, and therefore may not provide recommended substitutes for the item. In other embodiments, the substitution server 20 may selectively choose which items to provide recommended substitutions for based on user settings or past user preferences. For example, if Kleenex® was an added item and in the past the user did not select any of the recommended substitutes for Kleenex®, the substitution server 20 may not recommended substitutes for Kleenex®. As will be described in greater detail below, the substitution server 20 may be configured to recommend a potential substitute for a purchased item if the potential substitute is an adequate substitute for the purchased item and the potential substitute provides the user with an opportunity to save money. The substitution server 20 transmits a set of recommended substitutes for the item(s) included in the shopping list back to the computing device 10.

The computing device 10 receives the purchase history and the sets of recommended substitutes and displays them in the GUI 12. Referring now to FIG. 1B, an example of the GUI 12 is displaying purchased items appearing in the purchase history and is further displaying the recommended substitutes in relation to the purchased items to which they correspond. It is noted that a purchased item can indicate a brand of a purchased product as well as a unitary amount. In the illustrated example, the GUI 12 is displaying a first purchased item 42 indicating a 24-pack of PEPSI® and a second purchased item 44 indicating a box of VELVEETA® Shells & Cheese. Displayed in relation to the first purchased item 42 is a first set of recommended substitutes, which includes a first recommended substitute 46 indicating a 24-pack of COKE® and a second recommended substitute 48 indicating a 24-pack of Private Label Cola. Displayed in relation to the second purchased item 44 is a second of recommended substitutes, which includes a recommended substitute 50 indicating a box of Private Label Shells & Cheese.

Displayed in relation to the recommended substitutes are attributes associated with the recommended substitutes. As used herein, the term “attribute” can refer to any property that has been associated with the substitute product indicated by recommended substitute. Examples of attributes can include, but are not limited to, a substitute cost of the substitute product, a cost difference between the substitute product and the product indicated by the purchased item, a substitution weight indicating a degree of acceptability of the substitute product for the product, and a quality rating of the substitute product. In the illustrated example, the computing device 10 is displaying a cost difference attribute, i.e., cost difference attributes 52 and 54, and a substitution weight attribute, i.e., substitute weight attributes 56 and 58, in relation to the recommended substitutes for the 24-pack of PEPSI®. It should be appreciated that the computing device 10 can display other attributes in the GUI 12 or may not display any attributes in the GUI 12.

The user can provide user input to select purchased items and/or recommended substitutes for inclusion in an electronic shopping list. In the illustrated embodiment, the user can provide user input by touching a purchased item or a recommended substitute. For example, the user can touch a portion of the touch screen 11 that is displaying the purchased item 42 indicating a 24-pack of PEPSI® and the touch a portion of the touch screen 11 that is displaying the recommended substitute 50 indicating a box of Private Label Shells & Cheese. Such a sequence would indicate a selection of a 24-pack of PEPSI® and a box of Private Label Shells & Cheese. It should be appreciated that the GUI 12 can be configured to receive the user input in other manners including, but not limited to, receiving a mouse click, receiving manual input, and receiving speech input.

Once the user has selected the purchased items and/or the recommended substitutes, an updated electronic shopping list can be generated. Referring now to FIG. 1C, an example of the GUI 12 displaying an electronic shopping list is shown. In this example, the shopping list includes a first item 70 indicating a 24-pack of PEPSI® and a second item 72 indicating a box of Private Label Shells & Cheese.

Once the user has finished creating the electronic shopping list, the computing device 10 can store the modified electronic shopping list in memory. In some embodiments, the computing device 10 can also communicate the modified electronic shopping list to the substitution server 20 or another remote server (not shown). The substitution server 20 can utilize the modified electronic shopping list to track the user's substitutions and/or to provide a follow-up survey requesting a rating of the acceptability of the substitution for the product indicated by the originally provided item.

The examples of FIGS. 1A-1C are provided for example only and not intended to be limiting. It should be appreciated that variations of the GUI 12 are contemplated and are within the scope of the disclosure. Furthermore, while a mobile computing device is depicted, the computing device 10 can be a stationary computing device as well.

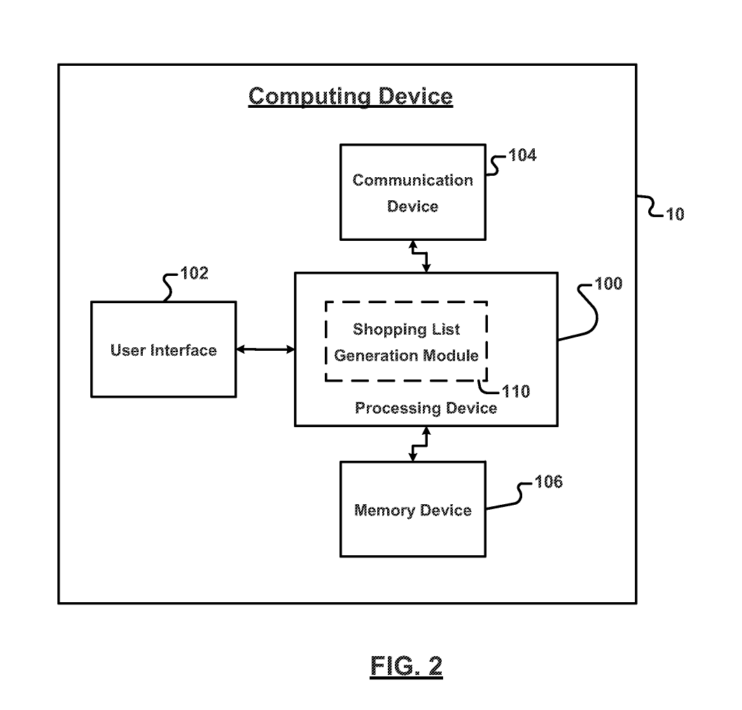

Referring now to FIG. 2, a block diagram illustrating example components of the computing device 10 of FIGS. 1A-1C is depicted. In the example embodiment, the computing device 10 includes a processing device 100, a user interface 102, a communication device 104, and a memory device 106.

The processing device 100 can include memory, e.g., read-only memory (ROM) and random access memory (RAM), which stores processor-executable instructions, and one or more processors that execute the processor-executable instructions. In embodiments where the processing device 100 includes two or more processors, the processors can operate in a parallel or distributed manner. The processing device 100 can execute the operating system of the computing device. In the illustrative embodiment, the processing device 100 also executes a shopping list generation module 110, which is described in greater detail below.

The user interface 102 is a device that allows a user to interact with the computing device 10. While one user interface 102 is shown, the term “user interface” can include, but is not limited to, a touch screen, a physical keyboard, a mouse, a microphone, and/or a speaker. The communication device 104 is a device that allows the computing device 10 to communicate with another device, e.g., the substitution server 30, via the network 20. The communication device 104 can include one or more wireless transceivers for performing wireless communication and/or one or more communication ports for performing wired communication. The memory device 106 is a device that stores data generated or received by the computing device 10. The memory device 106 can include, but is not limited to, a hard disc drive, an optical disc drive, and/or a flash memory drive.

In some embodiments, the shopping list generation module 110 is embodied as processor-executable instructions stored in the memory of the processing device 100. The processing device 100 can execute the shopping list generation module 110. The shopping list generation module 110 can be pre-loaded into the operating system of the computing device 10, can be downloaded from a third party server 10 by a user of the computing device 10, or be generated on the computing device 10.

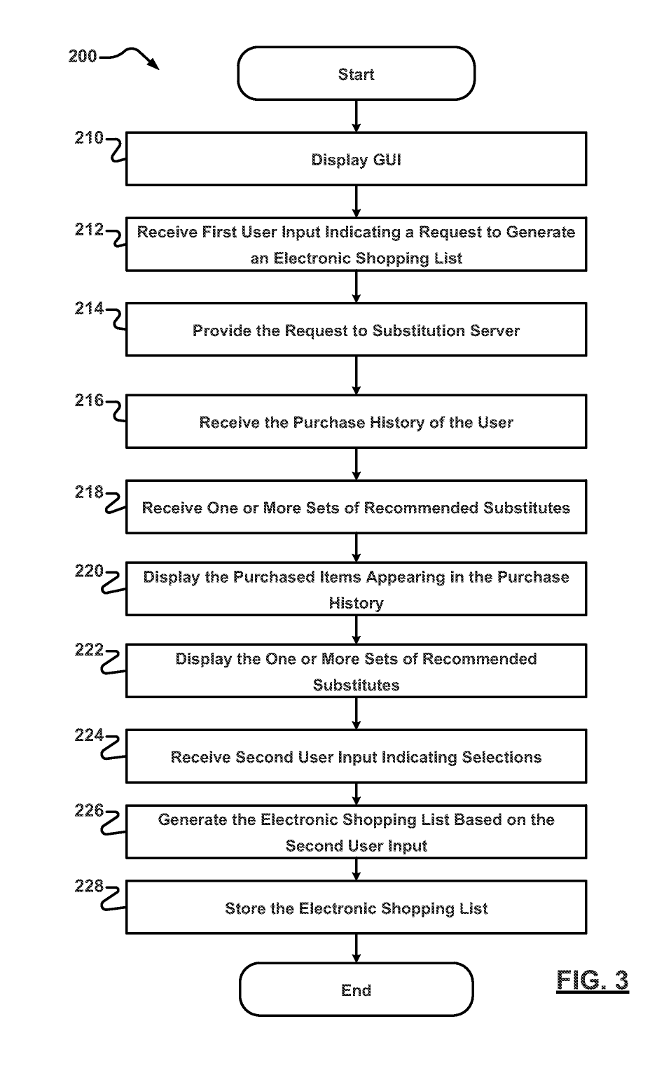

The shopping list generation module 110 provides the GUI 12 and allows a user to generate an electronic shopping list based on a purchase history of the user and recommended substitutes for purchased items appearing in the purchase history. FIG. 3 illustrates an example method 200 that can be executed by the shopping list generation module 110. At operation 210, the shopping list generation module 110 displays a GUI 12 that allows a user to provide a request to generate an electronic shopping list based on the user's purchase history. For example, the shopping list generation module 110 can display the GUI 12 of FIG. 1A or any other suitable GUI. At operation 212, the shopping list generation module 110 receives first user input, with the user input indicating the request for the recommended substitutes. In some embodiments, the first user input can be received via a one-touch button displayed in the GUI 12. At operation 214, the shopping list generation module 110 provides the request to the substitution server 20 via the network 30. As previously mentioned, the request may include an indicator of the user such as a username.

At operation 216, the shopping list generation module 110 receives the purchase history of the user. As discussed, the purchase history includes one or more purchased items. In some embodiments, each purchased item indicates a product that was previously purchased by the user from a retailer. The purchased item can indicate a brand of the product and a unitary amount of the product. At operation 218, the shopping list generation module 110 receives one or more sets of recommended substitutes. Each set of recommended substitutes can correspond to a different purchased item appearing in the purchase history. It should be appreciated that the purchase history and the corresponding recommended substitutes may be received together or separately.

At operation 220, the shopping list generation module 110 displays the purchased items appearing in the purchase history in the GUI 12. At operation 222, the shopping list generation module 110 displays the one or more sets of recommended substitutes in the GUI 12. In some embodiments, each set of recommended substitutes is displayed in relation to the purchased item to which the set of recommended substitute corresponds. For example, a set of recommended substitutes can be displayed directly below a purchased item to which it corresponds.

At operation 224, the shopping list generation module 110 receives a second user input indicating a selection. The second user input can indicate a selection of a purchased item and/or a recommended substitute. For example, the user may check a box displayed next to a specific purchased item to select the specific purchased item, or may press on the specific purchased item itself. At operation 226, the shopping list generation module 110 generates an electronic shopping list based on the second user input. As can be appreciated, the electronic shopping list indicates the purchased items and recommended substitutes that the user selected during operation 224. At operation 226, the shopping list generation module 110 can store the electronic shopping list in the memory device 106. Moreover, the shopping list generation module 110 can communicate the electronic shopping list to the substitution server 20, another remote server, or another computing device.

It should be appreciated that the shopping list generation module 110 may be configured to perform additional functions without departing from the scope of this disclosure. Furthermore, the method 200 described in FIG. 3 is provided for example only and not intended to be limiting. Variations of the method 200 are contemplated and are within the scope of the disclosure.

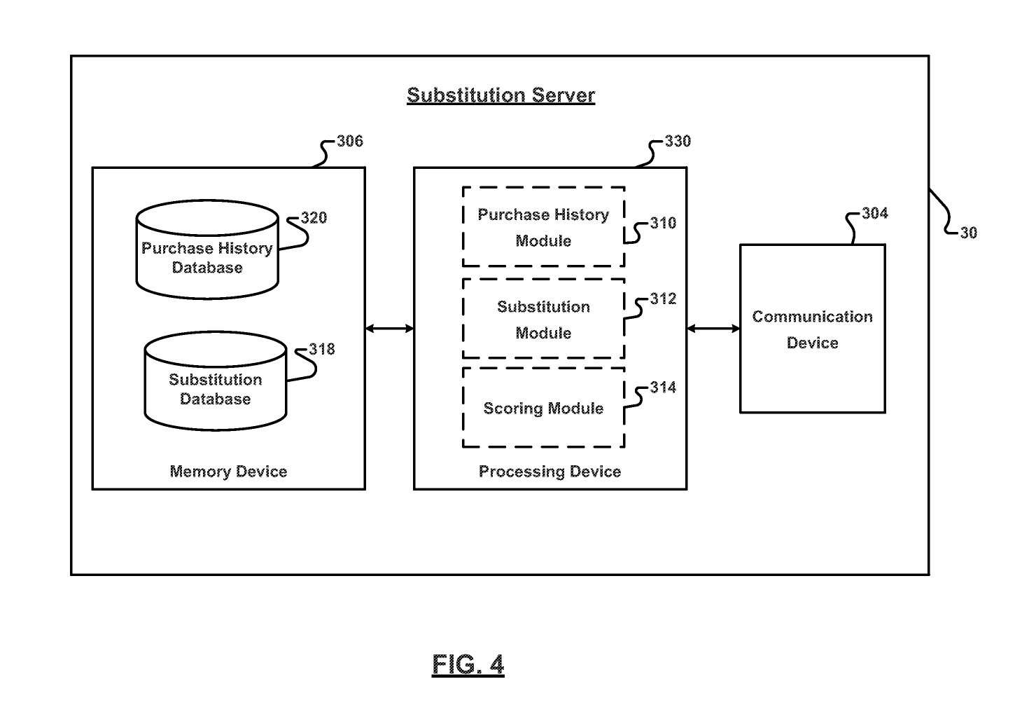

Referring now to FIG. 4, a block diagram illustrating an exemplary substitution server 20 is depicted. In an exemplary embodiment, the substitution server 20 includes a processing device 300, a communication device 304, and memory device 306.

The processing device 300 can include memory, e.g., read-only memory (ROM) and random access memory (RAM), storing processor-executable instructions, and one or more processors that execute the processor-executable instructions. In embodiments where the processing device 300 includes two or more processors, the processors can operate in a parallel or distributed manner. In the illustrative embodiment, the processing device 300 executes a purchase history module 310, a substitution module 312 and a scoring module 314, which are described in greater detail below.

The communication device 304 is a device that allows the substitution server 20 to communicate with another device, i.e., the computing device 10, via the network 30. The communication device 304 can include one or more wireless transceivers for performing wireless communication and/or one or more communication ports for performing wired communication.

The memory device 306 is a device that stores data generated or received by the substitution server 20. The memory device 306 can include, but is not limited to including, a hard disc drive, an optical disc drive, and/or a flash memory drive. Further, the memory device 306 may be distributed and located at multiple locations. The memory device 306 is accessible to the processing device 300. A substitution database 318, or a similar structure, can be stored in the memory device 306. In an exemplary embodiment, a retailer maintains the substitution server 20, such that the items and the substitutions corresponding thereto are all indicative of products offered by the retailer. Alternatively, the substitution server 20 can be maintained by a third party or a party affiliated with the retailer.

The substitution database 318 stores potential substitutes for a plurality of different items. In some embodiments, an item is related to one or more potential substitutes for the item. A potential substitute indicates one or more substitute products that could serve as a substitute for the product indicated by the item. In most cases, a substitute product is a single product that can replace the product indicated by the item. For example, a first brand of raisin bran cereal may be a potential substitute for a second brand of raisin bran. As should be appreciated, however, some products are sold as a combination of other products. For example, a taco kit may include tortillas, taco seasoning, and salsa. Thus, a potential substitute for a particular taco kit could include individual packages of tortillas, taco seasoning, and salsa. The combination of the individual products would constitute the substitute product for the taco kit. It should be appreciated that the potential substitutes can be determined for each item stored in the substitution database 318 in any suitable manner. For instance, the retailer that sells the products to consumers may determine the substitute products for the products sold by the retailer.

The substitution database 318 also stores attributes for each of the potential substitutes. As discussed, an attribute can be any property of the substitute product indicated by the potential substitute. A non-exhaustive list of attributes includes a substitute cost of the substitute product, a substitution weight of the substitute product, a cost difference between the substitute product and the product indicated by the item to which the potential substitute is related, a quality rating, a cost per unit, i.e., price per pound or fluid ounce, or a cost difference per unit.

The substitution weight can be a qualitative measure indicative of a degree of acceptability of a substitute product for a product. In some embodiments, the substitution weight is a value between 0 and 1. The acceptability of a substitute product for a product is unrelated to the cost of the product, but rather indicates whether the substitute product is likely to be accepted by a consumer when substituted for a particular product. A relatively low substitution weight can indicate that the substitute product is unlikely to be an acceptable substitute for the particular product. Similarly, a relatively high substitution weight can indicate that the substitute product is likely to be an acceptable substitute for the particular product. For example, COCA-COLA® may have a high substitution weight when related to PEPSI®, but may have a very low substitution weight when related to SPRITE®.

The attributes can be collected in any suitable manner. For example, the cost-related attributes can be provided by the retailer or calculated from other cost-related attributes. The qualitative measures such as substitution weight and quality rating can be collected from one or more consumers. For example, the substitution weight and/or the quality rating can be determined from consumer feedback, surveys, and/or consumer testing.

In some embodiments, a purchase history database 320 can also be stored on the memory device 306. It should be appreciated that in some embodiments, the purchase history database 320 may alternatively be stored at a remote server. The purchase history database 320 can store electronic receipts for a plurality of users and/or the purchase histories for a plurality of users. The electronic receipts can be received from any suitable source. In some embodiments, the electronic receipts can be provided from the retailer at the point of sale. For example, a user may swipe an ID card or enter a username/password at the point of sale when purchasing products. When the purchase is complete, an electronic receipt listing purchased items, which indicate the purchased products, can be sent to the substitution server 20 and stored in the purchase history database 320. Furthermore, the electronic receipt can be linked to the purchasing user in the purchase history database 320, such that a collection of electronic receipts corresponding to a user can be analyzed to determine a purchase history of a user.

In some embodiments, the purchase history of a user can also be stored in the purchase history database 320. In these embodiments, the purchase history module 310 can determine the purchase history of a user from the electronic receipts of the user.

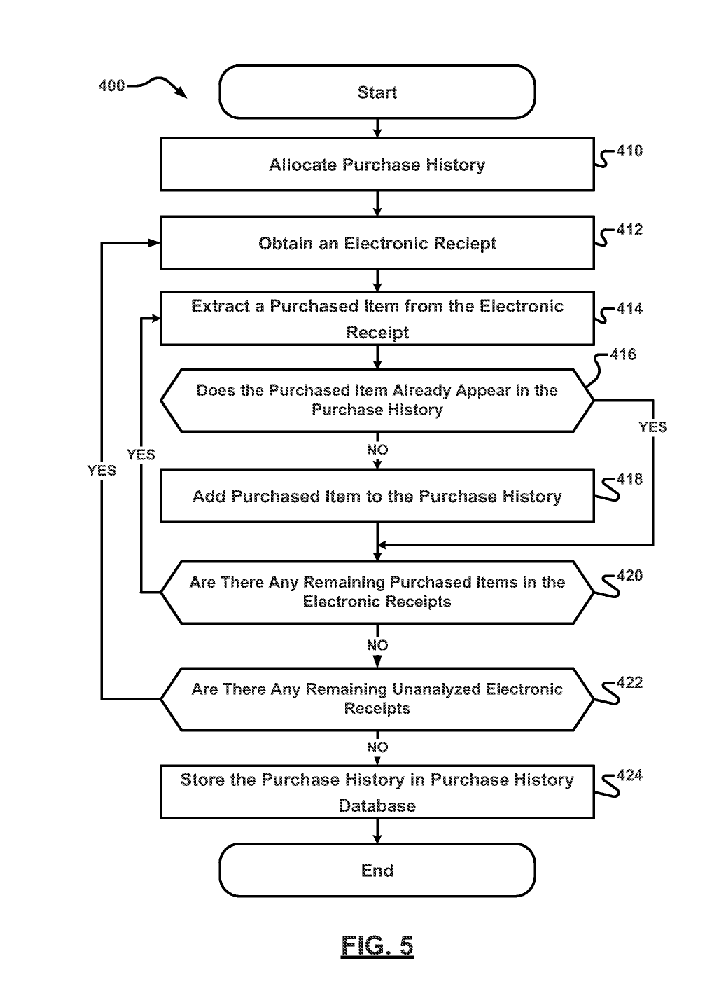

Referring to FIG. 5, an example method 400 that can be executed by the purchase history module 310 to determine the purchase history of a user is depicted. At operation 410, the purchase history module 310 allocates a purchase history of the user. Initially, the purchase history is empty and the purchase history module 310 can iteratively add purchase items to the purchase history as it analyzes the electronic receipts of a user.

At operation 412, the purchase history module 310 obtains an electronic receipt of the user from the purchase history database 320. In some embodiments, the purchase history module 320 may be configured to retrieve the oldest or newest unanalyzed electronic receipt in the purchase history database 320. In other embodiments, the purchase history module 320 can be configured to only obtain electronic receipts that are less than a predetermined age, e.g., less than one year.

At operation 414, the purchase history module 320 can extract a purchased item from the electronic receipt. At operation 416, the purchase history module 320 determines whether the purchased item has already been added to the purchase history. If the purchased item has not already been added to the purchase history, then the purchased item is added to the purchase history, as shown at operation 418. If the purchased item has already been added to the purchase history, then the purchased item is not added to the purchase history.

At operation 420, the purchase history module 320 determines whether there are more purchased items remaining in the electronic receipt. If so, the purchase history module 320 iterates back to operation 414 and extracts the next purchased item in the electronic receipt. If there are no remaining purchase items remaining in the electronic receipt, the purchase history module 320 determines whether there are any remaining unanalyzed electronic receipts corresponding to the user, as shown at operation 422. If there are any remaining unanalyzed electronic receipts, the purchase history module 310 iterates back to operation 412 and obtains the next unanalyzed electronic receipt. When all of the electronic receipts have been analyzed, the purchase history module 310 stores the purchase history in the purchase history database 320, as shown at operation 424.

The method 400 of FIG. 5 is provided for example only. It should be appreciated that the purchase history of a user can be determined in any suitable manner and variations of the method 400 are contemplated. For example, the purchase history module 310 may update the purchase history of a user each time a new electronic receipt is received. Furthermore, the purchase history module 310 may be configured to provide the purchase history to the substitution module 312 in addition to or in lieu of storing the purchase history in the purchase history database 320. Additionally, in some embodiments, a purchase item will not be added to the purchase history unless it appears in at least a specific predetermined amount of electronic receipts, e.g., in at three different electronic receipts.

Referring now back to FIG. 4, the substitution module 312 obtains the purchase history of a user and determines sets of recommended substitutes based on the purchased items contained in the purchase history. The substitution module 312 can obtain a purchase history of a user from the purchase history database 320 or directly from the purchase history module 310. For each purchased item, the substitution module 312 can determine a set of recommended substitutes. In some embodiments, a set of recommended substitutes for a purchased item can be an empty set if the substitution module 312 is unable to identify an adequate substitute for the purchased item.

The substitution module 312 can query the substitution database 318 with a purchased item. The substitution database 318 returns the potential substitutes that relate to the purchased item as well as the attributes associated with each potential substitute. The scoring module 314 can determine a score for each of the potential substitutes based on the attributes of the potential substitution. After the scoring module 314 has determined the score of a potential substitute, the substitution module 312 determines whether to recommend the potential substitute to the user, i.e., whether to include the potential substitute in the set of recommended substitutes, based on the score of the potential substitute. When the substitution module 312 has determined the sets of recommended substitutes for all of the purchased items in the purchase history, the substitution module 312 can communicate the sets of recommended substitutes to the computing device 10 via the communication device 304.

It is appreciated that the foregoing example of the substitution server 20 is not intended to be limiting. Variations of the exemplary substitution server 20 are contemplated and within the scope of the disclosure. For example, the memory device 306 may store a look-up table or a hash table that relates purchased items to potential substitutes.

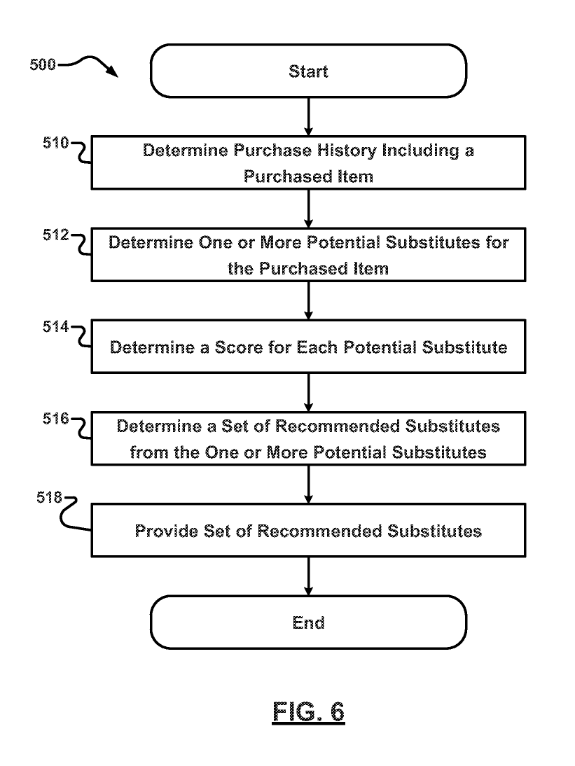

Referring now to FIG. 6, an exemplary method 500 for determining a set of recommended substitutes for a purchased item is illustrated. In some embodiments, the method 500 is executed by processing device 330 of the substitution server 20. As discussed above, the substitution module 312 obtains a purchase history that contains one or more purchased items of a user. The method 500 of FIG. 6 explains the process of determining a set of recommended substitutes for one purchased item. It should be appreciated, however, that the techniques disclosed herein can be applied to determine sets of recommended substitutes for each of the purchased items in the purchase history of a user.

At operation 510, the substitution module 312 obtains a purchased item from the purchase history of the user. The purchased item can be indicative of a product purchased by a user from a retailer. In some embodiments, the purchased item may indicate a brand of the product and a unitary amount of the product. For example, a purchased item may indicate a 24-pack of PEPSI®.

At operation 512, the substitution module 312 determines one or more potential substitutes for the purchased item. In some embodiments, the substitution module 312 queries the substitution database 318 using the purchased item to determine the one or more potential substitutes. The substitution database 318 returns the potential substitutes that have been related to the purchased item in the substitutions database 318. Using the example provided above, in response to an item indicating a 24-pack of PEPSI®, the substitution module 312 may determine that the potential substitutes related to the 24-pack of PEPSI are a 24-pack of COCA-COLA, a 24-pack of a Private Label Cola, a 24-pack of Private Label Root Beer, and a 6-pack of PEPSI®. Furthermore, the substitution database 318 can return the attributes associated with each of the potential substitutes.

At operation 514, the scoring module 314 determines a score for each potential substitute based on the attributes of the potential substitute. In some embodiments, the scoring module 314 can determine the score of a potential substitute based on the substitution weight of the potential substitute and the cost difference between the substitute cost of the substitute product and the product cost of the purchased product. For example, the score of a potential substitute may be determined according to:

S_{P}=ΔC*w

where S_{P} is the score of a potential substitute, P, ΔC is the cost difference between the substitute cost and the product cost, and w is the substitution weight of the potential substitute. It should be appreciated that the score can be calculated in any other suitable manner. Additionally, the manner in which the score is calculated can be designed to put a greater emphasis on either cost difference or substitution weight. Furthermore, the score can be based on additional attributes such as the quality rating of the potential substitute.

At operation 516, the substitution module 312 determines a set of recommended substitutes from the one or more potential substitutes based on the scores thereof. In some embodiments, the substitution module 312 compares the score of a potential substitute to a score threshold. If the score exceeds the score threshold, the potential substitute is included in the set of recommended substitutes. If none of the scores exceed the score threshold, the set of recommended substitutes may be empty. The score threshold can be determined in any suitable manner. For example, the retailer or the user to whom the purchase history corresponds can set the score threshold. Alternatively, the score threshold may be determined by monitoring feedback from consumers regarding previous substitution recommendations using a neural network, or any other suitable learning technique. It should be appreciated that the set of recommended substitutes can be determined in other manners as well. For example, the substitution module 312 can include the M highest (e.g., M=3) scored potential substitutes in the set of recommended substitutes.

At operation 518, the set of recommended substitutes is provided to the computing device 10. It should be appreciated that the set of recommended substitutes may be combined with other sets of recommended substitutes, which are collectively transmitted to the computing device 10. Furthermore, the purchase history of the user may also be provided to the computing device 10.

The method 500 of FIG. 6 is provided for example and not intended to be limiting. It should be appreciated that the method 500 may include additional operations and some operations may be varied without departing from the scope of the disclosure.

The above description of illustrated examples of the present invention, including what is described in the Abstract, are not intended to be exhaustive or to be limited to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A computer-implemented method comprising:
obtaining, at a processing device of a computing device, a purchase history of a user, the purchase history including a purchased item that indicates a purchased product previously purchased by the user from a retailer;
determining, at the processing device, one or more potential substitutes for the purchased item based on the purchased item, the potential substitute being indicative of a substitute product for the product wherein a plurality of attributes are associated with each potential substitute, the plurality of attributes including a substitute cost of the substitute product and a substitution weight corresponding to the potential substitute, the substitution weight being indicative of a degree of acceptability of the substitute product for the purchased product;
for each of the one or more potential substitutes, determining, at the processing device, a score of the potential substitute based on the plurality of attributes associated with the potential substitute;
determining, at the processing device, a set of recommended substitutes from the one or more potential substitutes based on the scores of the one or more potential substitutes; and
providing, at the processing device, the purchase history and the set of recommended substitutes for display to the user.

2. The method of claim 1, wherein each of the one or more potential substitutes includes one or more alternate items collectively defining the potential substitute.

3. The method of claim 1, wherein the purchase history includes a plurality of purchased items including the purchased item, each purchased item indicating a different purchased product previously purchased by the user from the retailer.

4. The method of claim 3, wherein obtaining the purchase history of the user includes:
obtaining, at the processing device, one or more electronic receipts corresponding to the user, each electronic receipt corresponding to a particular time and indicating one or more different purchased items;
for each of the one or more electronic receipts:
a) extracting the one or more different purchased items from the electronic receipts; and
b) for each of the one or more different purchased items, adding the different purchased item to the purchase history when the different purchased item has not previously added to the purchase history.

5. The method of claim 1, wherein the score of each potential substitute is based on the substitution weight associated with the potential substitute and a difference between the substitute cost of the substitute product and a product cost of the purchased product.

6. The method of claim 5, wherein the score of each potential substitute is based on a product of the difference and the substitution weight associated with the potential substitute.

7. The method of claim 1, wherein determining the set of recommended substitutes includes, for each of the one or more potential substitutes:
comparing the score of the potential substitute with a score threshold; and
including the potential substitute in the set of recommended substitutes when the score exceeds the score threshold.

8. The method of claim 1, wherein obtaining the one or more potential substitutes includes querying a substitution database using the purchased item, the substitution database relating the one or more potential substitutes to the purchased item.

9. The method of claim 8, wherein the substitution database stores entries for a plurality of different items, each of the items having a set of potential substitutes related thereto.

10. A substitution server having a processing device, the substitution server comprising:
a purchase history module configured to determine a purchase history of a user, the purchase history including a purchased item that indicates a purchased product previously purchased by the user from a retailer;
a substitution module configured to determine one or more potential substitutes for the purchased item based on the purchased item, the potential substitute being indicative of a substitute product for the purchased product wherein a plurality of attributes are associated with each potential substitute, the plurality of attributes including a substitute cost of the substitute product and a substitution weight corresponding to the potential substitute, the substitution weight being indicative of a degree of acceptability of the substitute product for the purchased product;
a scoring module configured to determine, for each of the one or more potential substitutes, a score of the potential substitute based on the plurality of attributes associated with the potential substitute;
wherein the substitution module is further configured to determine a set of recommended substitutes from the one or more potential substitutes based on the scores of the one or more potential substitutes and to provide the purchase history and the set of recommended substitutes for display to the user.

11. The server of claim 10, wherein each of the one or more potential substitutes includes one or more alternate items collectively defining the potential substitute.

12. The server of claim 10, wherein the purchase history includes a plurality of purchased items including the purchased item, each purchased item indicating a different purchased product previously purchased by the user from the retailer.

13. The server of claim 12, wherein the purchase history module is configured to determine the purchase history by:
obtaining one or more electronic receipts corresponding to the user, each electronic receipt corresponding to a particular time and indicating one or more different purchased items;
for each of the one or more electronic receipts:
a) extracting the one or more different purchased items from the electronic receipts; and
b) for each of the one or more different purchased items, adding the different purchased item to the purchase history when the different purchased item has not previously added to the purchase history.

14. The server of claim 12, further comprising a purchase history database that stores purchase histories for a plurality of users including the user, wherein the purchase history module obtains the purchase history from the purchase history database.

15. The server of claim 10, wherein the score of each potential substitute is based on the substitution weight associated with the potential substitute and a difference between the substitute cost of the substitute product and a product cost of the purchased product.

16. The server of claim 15, wherein the score of each potential substitute is based on a product of the difference and the substitution weight associated with the potential substitute.

17. The server of claim 10, wherein the substitution module determines the set of recommended substitutes for the purchased item by, for each of the one or more potential substitutes:
comparing the score of the potential substitute with a score threshold; and
including the potential substitute in the set of recommended substitutes when the score exceeds the score threshold.

18. The server of claim 10, wherein the substitution module obtains the one or more potential substitutes includes querying a substitution database using the purchased item, the substitution database relating the one or more potential substitutes to the purchased item.

19. The server of claim 19, wherein the substitution database stores entries for a plurality of different items, each of the items having a set of potential substitutes related thereto.

20. A computer-implemented method executed by a processing device of a computing device, comprising:
displaying, at the computing device, a graphical user interface that allows a user to request to generate an electronic shopping list based on a purchase history of the user;
receiving, at the computing device, first user input indicating a request for the recommended substitutes;
providing, from the computing device, the request to a remote server;
receiving, at the computing device, a purchase history of the user indicating one or more purchased items, each purchased item indicating a purchased product previously purchased by the user from the retailer;
receiving, at the computing device, one or more sets of recommended substitutes, each set of recommended substitutes corresponding to one of the one or more purchased items and indicating one or more substitutes for one of purchased items;
displaying, at the computing device, the one or more purchased items in the graphical user interface;
displaying, at the computing device, each of the one or more sets of recommended substitutes in relation to the purchased item to which the set of recommended substitutes corresponds;
receiving, at the computing device, second user input indicating selections of one or more substitutes displayed in the graphical user interface;
generating, at the computing device, the electronic shopping list based on the second user input; and
storing, at the computing device, the electronic shopping list.

21. The method of claim 19, wherein the graphical user displays a one-touch button, wherein when the one-touch button is selected by the user, the electronic shopping list is automatically provided to the remote server without any additional user input.
